(19) United States
(12) Patent Application Publication
(10) Pub. No.: US 2008/0144211 A1
(43) Pub. Date: Jun. 19, 2008

(54) Servo techniques that mitigate an effect of read and write velocity variations on position error signal calculations

(76) Inventors: Mark P. Weber, Oakdale, MN (US); Denis J. Langlois, River Falls, WI (US)

Correspondence Address: Imation Corp., PO Box 64898, St. Paul, MN, 55164-0898, US

(21) Appl. No.: 11/641,422

(22) Filed: Dec. 18, 2006

(51) Int. Cl. G11B 5/584

(52) U.S. Cl. 360/77.12

(57) ABSTRACT

In general, the invention is directed to servo techniques that make use of time-based servo patterns that can substantially mitigate error in a position error signal (PES) calculation resulting from a variation in tape velocity. A servo pattern including at least three marks is written using a single pulse and a single servo head such that the spacing of the servo marks in the servo pattern is not dependent on write velocity. By measuring the time between detection of at least three servo marks in the servo pattern, a ratio of time increments can be used to factor out read tape velocity. In order to facilitate this effect, techniques for determining the relationship between a ratio of time increments and a PES signal are described. Also described are techniques for configuring a servo pattern that provides a linear relationship between a ratio of time increments and a PES signal.

### TECHNICAL FIELD

The invention relates to data storage media and, more particularly but without limitation, to magnetic storage media recorded with servo patterns.

### BACKGROUND

Data storage media are commonly used for storage and retrieval of data and come in many forms, such as magnetic tape, magnetic disks, optical tape, optical disks, holographic disks or cards, and the like. In magnetic media, data is typically stored as magnetic signals that are magnetically recorded on the medium surface. The data stored on the medium is typically organized along “data tracks,” and transducer heads are positioned relative to the data tracks to read or write data on the tracks. A typical magnetic storage medium, such as magnetic tape, usually includes several data tracks. Optical media, holographic media and other media formats can also make use of data tracks.

During data storage and recovery, the head must locate each data track, and follow the path of the data track accurately along the media surface. In order to facilitate precise positioning of the transducer head relative to the data tracks, servo techniques have been developed. Servo patterns refer to signals or other recorded marks on the medium that are used for tracking purposes. In other words, servo patterns are recorded on the medium to provide reference points relative to the data tracks. A servo read head has a fixed displacement relative to the transducer head that reads the data tracks. The servo read head can read the servo patterns, and a servo controller interprets a detected servo pattern and generates a position error signal (PES). The PES is used to adjust the lateral distance of the servo read head relative to the servo pattern and the transducer head relative to the data tracks so that the transducer head is properly positioned along the data tracks for effective reading and/or writing of data to the data tracks.

With some data storage media, such as magnetic tape, the servo patterns are stored in specialized tracks on the medium, called “servo bands.” Servo bands serve as references for the servo controller. A plurality of servo patterns may be defined in a servo band. Some magnetic media include a plurality of servo bands, with data tracks being located between the servo bands.

One type of servo pattern is a time-based servo pattern. Time-based servo techniques refer to servo techniques that make use of non-parallel servo marks and time variables or distance variables to identify head position. The time offset between the detection of two or more servo marks can be translated into a PES, which defines a lateral distance of the transducer head relative to a data track. For example, given a constant velocity of magnetic tape formed with servo pattern “/ \”, the time between detection of mark “/” and mark “\” becomes longer when the read head is positioned towards the bottom of pattern “/ \” and shorter if the read head is positioned towards the top of pattern “/ \”. Given a constant velocity of magnetic media, a defined time period between detected servo signals may correspond to a center of pattern “/ \”. By locating the center of pattern “/ \”, a known distance between the center of the servo band and the data tracks can be identified. Time-based servo patterns are also commonly implemented in magnetic tape media, but may be useful in other media.

### SUMMARY

In general, the invention is directed to servo techniques that make use of time-based servo patterns that can substantially mitigate error in a position error signal (PES) calculation resulting from a variation in velocity of the data storage tape. A servo pattern including at least three marks is written using a single pulse and a single servo head such that the spacing of the servo marks in the servo pattern is not dependent on write velocity. By measuring the time between detection of at least three servo marks in a servo pattern, a ratio of time increments can be used to factor out tape velocity. In order to facilitate this effect, techniques for determining the relationship between a ratio of time increments and a PES signal are described.

Also described are techniques for configuring a servo pattern that provides a linear relationship between a ratio of time increments and a PES signal. In some embodiments, a time-based servo pattern including three non-identical servo marks may be configured to provide a linear PES calculation. A linear PES calculation results when a position error has a linear relationship to a ratio of time measurements between detection of servo marks in a servo pattern. In this manner, PES calculations may be simplified, which may allow faster PES calculations without using a look-up table.

In one embodiment, the invention is directed to data storage tape comprising one or more data tracks and a series of servo patterns to facilitate head positioning relative to the data tracks. Each of the servo patterns includes a first servo mark, a second servo mark and a third servo mark. At least one of the first servo mark, the second servo mark and the third servo mark is a non-linear servo mark. A distance “A” is defined as a first distance in a down-tape direction between the first servo mark and the second servo mark. A distance “B” is defined as a second distance in a down-tape direction between the first servo mark and the third servo mark. A/B is linearly related to a cross-tape position at which A and B are defined.

In another embodiment, the invention is directed to a method comprising detecting a first servo mark, a second servo mark and a third servo mark of a servo pattern on a data storage tape with a head. The first servo mark, the second servo mark and the third servo mark have non-identical geometries. The method further comprises calculating a position error signal according to a cross-tape position of the head relative to the data storage tape according to time intervals between the detection of the first servo mark, the second servo mark and the third servo mark. Calculating the position error signal substantially mitigates an error in the calculated position error signal resulting from a variation in velocity of the data storage tape during detection of the first servo mark, the second servo mark and the third servo mark.

In another embodiment, the invention is directed to data storage tape comprising one or more data tracks; and a series of servo patterns to facilitate head positioning relative to the data tracks, wherein each of the servo patterns includes a first non-linear servo mark and a second non-linear servo mark.

The details of several embodiments of the invention are set forth in the accompanying drawings and the description below. Other features, objects, and advantages of the invention will be apparent from the description and drawings and from the claims.

### BRIEF DESCRIPTION OF DRAWINGS

FIG. 1 is a block diagram illustrating an exemplary servo writing system for pre-recording servo patterns on magnetic tape.

FIG. 2A is a top view of an exemplary servo head.

FIG. 2B is a side view of the exemplary servo head illustrated in FIG. 2A.

FIG. 3 is a conceptual view of a data storage tape including a series of servo patterns recorded in servo bands.

FIG. 4 is a conceptual view of a servo pattern including three servo marks.

FIG. 5 is a conceptual view of a servo pattern including three linear servo marks, wherein the three linear servo marks have non-identical geometries.

FIG. 6 is a conceptual view of a servo pattern including three servo marks with two of the three being linear servo marks.

FIG. 7 is an illustration of a servo pattern that provides a linear cross-tape position error calculation.

FIG. 8 is a conceptual view of a servo pattern including three servo marks with one of the three being a linear servo mark.

FIG. 9 is a flow diagram illustrating a time-based method for adjusting a read head's position.

### DETAILED DESCRIPTION

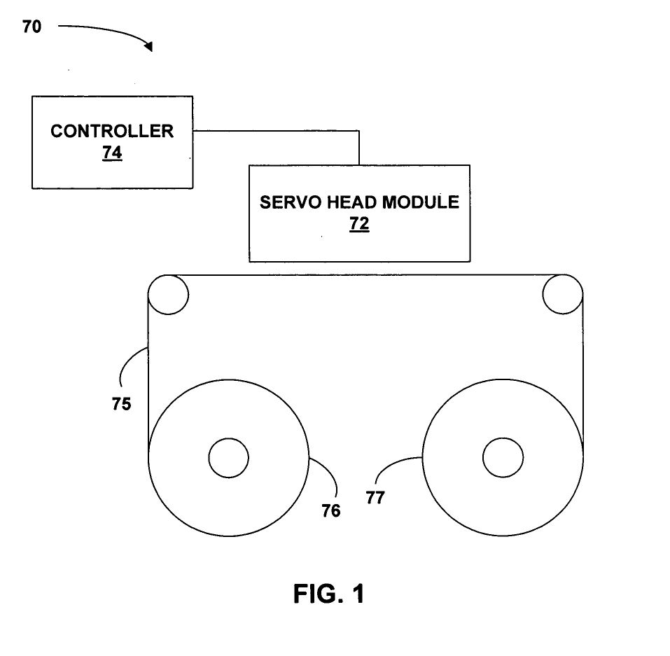

FIG. 1 is a block diagram illustrating an exemplary servo writing system 70 for pre-recording servo patterns on magnetic tape 75. System 70 includes servo head module 72, servo controller 74, and magnetic tape 75 spooled on spools 76 and 77. Servo head module 72 contains one or more servo heads to write servo patterns on magnetic tape 75. Controller 74 controls the magnetic fields applied by the one or more servo heads of servo head module 72. Magnetic tape 75 feeds from spool 76 to spool 77, passing in close proximity to servo head module 72. For example, magnetic tape 75 may contact the one or more servo heads of servo head module 72 during servo recording.

Servo head module 72 comprises electromagnetic elements that generate magnetic fields. In one embodiment, controller 74 may cause a first servo head to write substantially over the full servo band associated with magnetic tape 75. Then, controller 74 can cause at least one additional servo head within servo head module 72 to selectively erase servo marks within the prerecorded servo band.

In a different embodiment, the servo band portion of magnetic tape 75 may be randomly magnetized. Controller 74 may cause at least one servo head within servo head module 72 to write servo marks within a randomly magnetized servo band.

A servo head on servo head module 72 provides a servo pattern with at least three servo marks. For example, the servo head may provide a time-based servo pattern that allows a linear position error signal (PES) calculation. In some embodiments, the servo pattern provides a linear relationship between the PES and a ratio of time increments between detection of servo marks in the servo pattern to allow a linear formula to be used in the PES calculation, hereinafter referred to as a “linear PES calculation”.

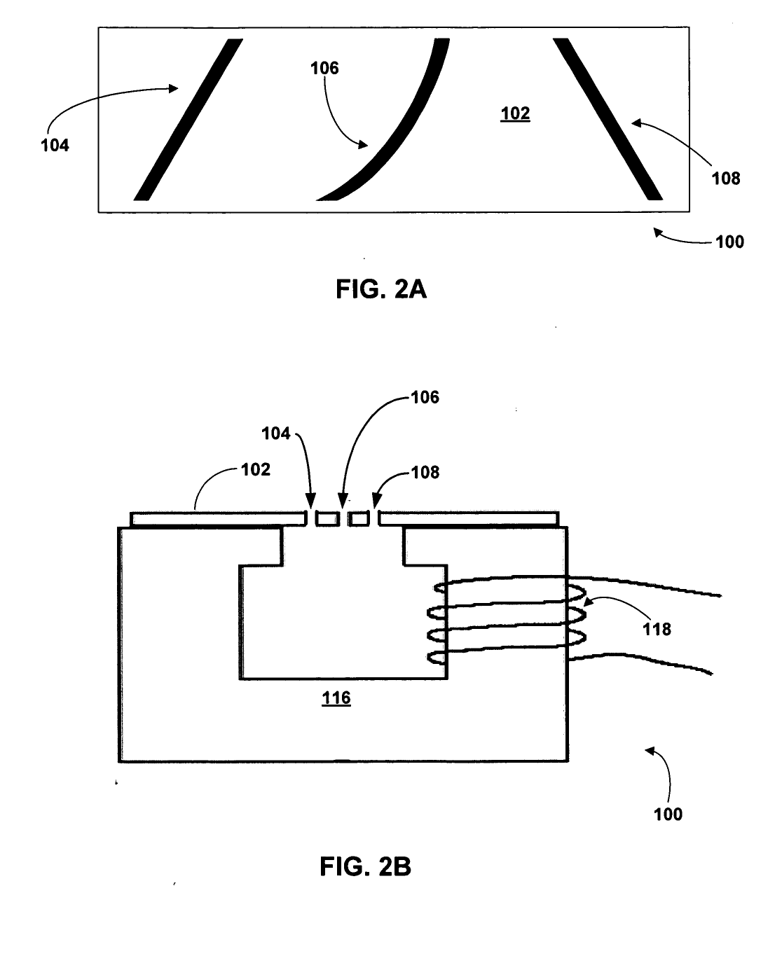

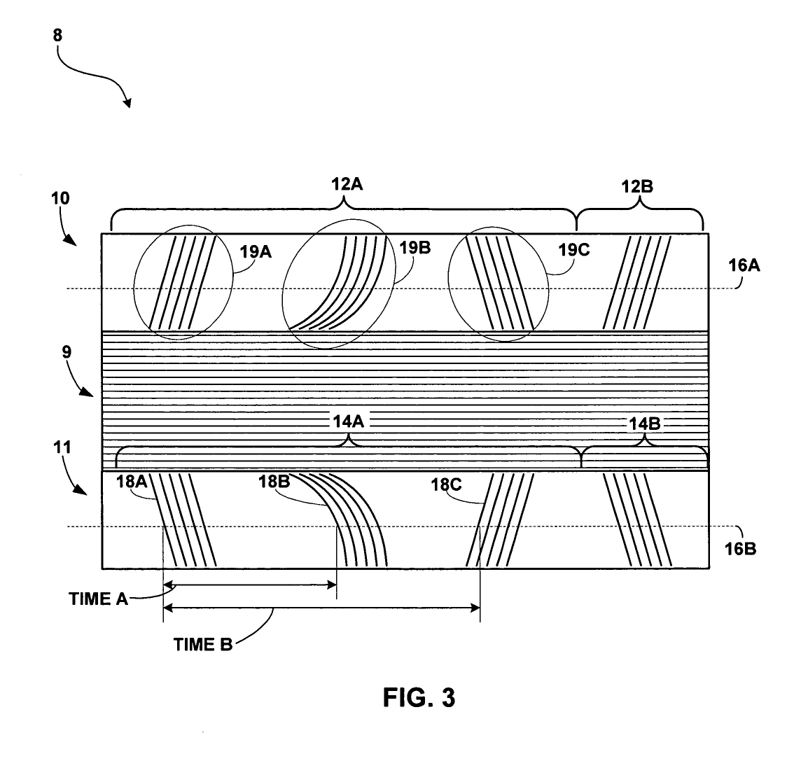

FIG. 2A is a top view of exemplary servo head 100 comprising write gaps 104, 106 and 108. FIG. 2B is a cross-sectional conceptual view of the exemplary servo head illustrated in FIG. 2A. Servo head 100 is configured to record a servo pattern on magnetic media. For example, servo head 100 may be a part of servo head module 72 in FIG. 1.

Controller 74 (FIG. 1) applies electrical signals to servo head 100 via coil 118 in order to generate magnetic fields across gaps 104, 106 and 108. For example, electric pulses may be applied to servo head 100 via coil 118 in order to generate magnetic fields across gaps 104, 106 and 108. A single electrical pulse records a single servo pattern consisting of three servo marks: one servo mark for each of gaps 104, 106 and 108. In some embodiments the servo pattern allows a linear PES calculation.

In operation, servo head 100 generates timed pulses of magnetic signals to write gaps 104, 106 and 108 as the magnetic tape passes relative to servo head 100. With the magnetic tape moving relative to servo head 100, the timed pulses of magnetic fields from write gaps 104, 106 and 108 leave recorded servo marks to create a servo frame on the magnetic tape, similar to servo frame 12A in FIG. 3, for example. If desired, additional servo heads may be used with servo head 100 for simultaneous creation of servo frames on additional servo bands.

Because gap 106 is non-linear, gap 106 cannot provide both a uniform flux density and a uniform angle at which the flux travels. For example, if gap 106 is designed to have a uniform dimension in a down tape direction, the amplitude of the flux and the angle of flux will vary. Designing gap 106 to keep the flux density constant results in variation in the angle of flux travel. Likewise, designing gap 106 to keep the angle of flux travel constant results in flux density variations. It may be useful to design gap 106 by balancing amplitude loss due to azimuth error in the angle at which the flux travels and amplitude loss due to flux density variation at different locations across gap 106. The width of gap 106 corresponds to the width of servo marks written by gap 106. Hereinafter, servo marks are described theoretically as without reference to their actual widths. Some experimentation may be useful to determine the most suitable width for servo marks for a given application.

Servo head 100 may be manufactured using micromanufacturing techniques such as deposition, masking and etching. For example, magnetic layer 102 may be formed or etched to define gaps 104, 106 and 108, that in turn define the servo pattern. Magnetic layer 102 may comprise a magnetically permeable layer that is deposited over electromagnetic element 116 via masking techniques to define a pattern of gaps as described herein. Alternatively, magnetic layer 102 may comprise a magnetically permeable layer deposited over electromagnetic element 116 and then etched to define patterns of gaps. Also, magnetic layer 102 may be pre-formed to define the gaps and then adhered to electromagnetic element 116 to define servo head 100. In other embodiments, gaps 104, 106 and 108 may be formed directly in electromagnetic element 116 to define the servo pattern to be created by servo head 100.

FIG. 3 is a conceptual view illustrating data storage tape 8 including data tracks 9, servo band 10 and servo band 11. As referred to herein, a servo mark is a continuous shape that can be sensed as a read head passes over a media surface. Time-based servo marks are generally lines, but not necessarily straight lines; e.g., in some embodiments, time-based servo marks may have zigzag or curved shapes. With respect to magnetic tape, a servo mark is generally written by a single write gap in a servo head with a single electromagnetic pulse. The term servo marks encompasses servo stripes, which are straight, and also includes curved servo marks and servo marks with other shapes.

A servo pattern includes a plurality of servo marks. The plurality of servo marks in a single time-based servo pattern allows calculation of a PES using time measurements between the detection of servo marks within the pattern by a read head. Generally, all servo marks within a single servo pattern are written using a single electromagnetic pulse so that any inconsistency in tape speed during the servo writing does not affect the spacing of servo marks within a servo pattern. As referred to herein, a servo frame includes at least one servo pattern, although servo frames often include more than one servo pattern. As an example, servo band 10 includes servo frames 12A-12B (“frames 12”). Each of servo frames 12 includes five servo patterns. Servo patterns in servo frames having more than one servo pattern are generally written with the same servo head using one electromagnetic pulse for each servo pattern in the servo frame. For example, each of servo frames 12 was written using five electromagnetic pulses.

Commonly shaped adjacent servo marks of separate servo patterns within a servo frame are generally written using the same write gap. These commonly-shaped adjacent servo marks of separate servo patterns within a servo frame are referred to herein as a burst. The term burst is in reference to the signal detected as a head passes over the servo marks that make up a burst. For example, servo fame 12A includes bursts 19A-19C. In some embodiments, servo frames may overlap as can servo marks, servo patterns and bursts. For simplicity, no overlapping servo marks, servo patterns, bursts or servo frames are shown in FIG. 3.

Servo frames 12 each include five servo patterns, and each servo pattern includes three servo marks with a single non-linear mark. For example, the five marks in burst 19B are non-linear. Frame 12B is incomplete as it extends beyond the portion of data storage tape 8 shown in FIG. 3. All of the servo patterns in servo band 10 were written by the same servo write head and are substantially identical. Servo band 11 also includes two servo frames 14A and 14B (“frames 14”). Each of frames 14 also includes five servo patterns. Again only a portion of servo frame 14B is shown in FIG. 3. As with servo band 10, all of the servo patterns in servo band 11 are written by the same servo write head and are identical. The servo patterns in servo band 10 are shown as being inverted relative to the servo patterns in servo band 11. However, in other embodiments, each servo band may have the same or a unique servo pattern.

The servo patterns in servo bands 10 and 11 facilitate positioning of a read head relative to data tracks 9, which reside a known distance from servo bands 10 and 11. The location of a read head along one of head paths 16A and 16B (“paths 16”) is determined by measuring the time between detection of marks forming a servo pattern. Servo marks 18A-18C (“marks 18”) form the first servo pattern in servo frame 14A. Servo marks 18 have non-identical geometries in that their geometries differ from one another other than simply being transposed from one another in a down-tape direction. For example, servo marks having non-identical geometries include a linear servo mark compared to a non-linear servo mark. Two linear servo marks which are at different angles relative to a cross-tape direction also have non-identical geometries. Similarly, two non-linear servo marks having the same general shape at different angles relative to a cross-tape direction have non-identical geometries. In contrast, each servo mark of a burst, e.g., the five servo marks of burst 19A, has an identical geometry. As data storage tape 8 passes by a read head located along head path 16B, the read head first detects servo mark 18A. The next servo mark in the first servo pattern of servo frame 14A detected by the read head is servo mark 18B. The time between the detection of servo mark 18A and servo mark 18C is shown as “TIME B” in FIG. 3. From this measurement, the position of the read head within servo band 11 can be determined because the distance between servo marks 18A and 18C varies as a function of the lateral position of the path of the read head. For example, if head path 16B were closer to data tracks 9, TIME B would be greater. Likewise, if head path 16B were further from data tracks 9, TIME B would be shorter.

The relationship between the measured TIME B and the position of the read head within servo band 11 is dependent on the tape speed of data storage tape 8 as it passes over the read head. A third servo mark, servo mark 18B, is used to account for tape speed fluctuations. In some embodiments, the curve of servo mark 18B is configured such that the ratio of TIME A to TIME B has a linear relationship to the position of a head on head path 16B. Thus, using the known relationship between the position of a head on head path 16B and the ratio of TIME A to TIME B allows an accurate calculation of the location of head path 16B.

By locating the positions of head paths 16 relative to servo bands 10 and 11, a PES can be generated to identify lateral positioning error of the read head relative to the data track(s). While PES calculations require only a single servo pattern, data from multiple servo patterns within a servo band may be combined to improve accuracy of a PES. Each of the servo patterns in servo band 10 is substantially identical to each other, and the servo patterns in servo band 11 are also substantially identical to each other. This means that the same PES calculation formula may be used for every servo pattern in a servo band.

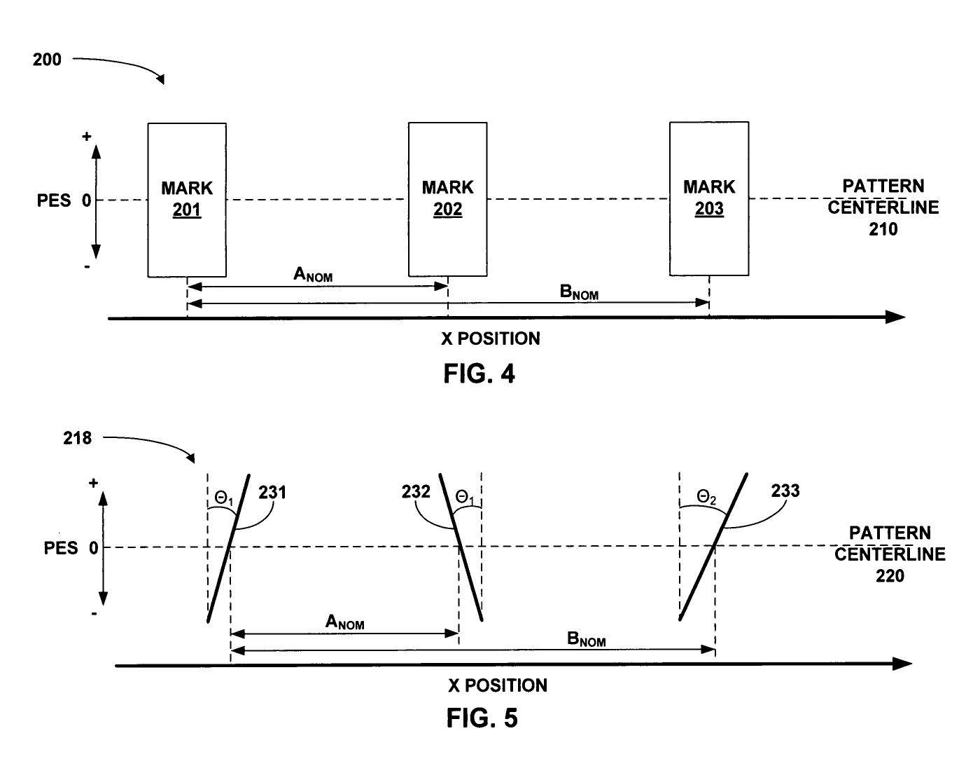

FIG. 4 is a conceptual view of servo pattern 200, which includes servo marks 201, 202 and 203. Pattern centerline 210 is shown to indicate the center of servo pattern 200 in a cross-tape direction. The distance between servo mark 201 and servo mark 202 along pattern centerline 210 is shown as Aₙₒₘ. Similarly, the distance between servo mark 201 and servo mark 203 along pattern centerline 210 is shown as Bₙₒₘ. A read head traversing pattern centerline 210 would provide time measurements corresponding to Aₙₒₘ and Bₙₒₘ. The ratio of the time measurements corresponding to Aₙₒₘ and Bₙₒₘ would provide a PES of zero at any tape velocity. In this manner, the ratio of the time measurements corresponding to Aₙₒₘ and Bₙₒₘ can account for any tape speed variation during the reading of servo pattern 200. If a read head detecting servo pattern 200 deviated from pattern centerline 210, the time measurement between the detection of marks 201 and 202 and also the time measurement between the detection of marks 201 and 203 would be different from the time measurements corresponding to Aₙₒₘ and Bₙₒₘ. The exact position error may be calculated using the known geometry of servo marks 201, 202, and 203.

For example, marks 201, 202 and 203 may be defined according to their respective geometry such that:

X=f₁(PES) Equation 1

X=f₂(PES) Equation 2

X=f₃(PES) Equation 3

In Equations 1-3, f₁ represents the geometry of mark 201, f₂ represents the geometry of mark 202, and f₃ represents the geometry of mark 203. In Equations 1-3, f₁, f₂ and f₃ are only defined for the range of X in which servo marks 201, 202 and 203 respectively exist. Using the following formulas, it can be shown that servo marks 201, 202 and 203 may be used to cancel and read velocity error:

$$\begin{matrix}{A}_{written} = - {f}_{1} ( PES ) + {f}_{2} ( PES ) & Equation 4 \\ {B}_{written} = - {f}_{1} ( PES ) + {f}_{3} ( PES ) & Equation 5 \\ {A}_{read} = {A}_{written} * \frac{{V}_{read\_nom}}{{V}_{read\_act}} & Equation 6 \\ {B}_{read} = {B}_{written} * \frac{{V}_{read\_nom}}{{V}_{read\_act}} & Equation 7 \\ \frac{{A}_{read}}{{B}_{read}} = \frac{{A}_{written * \frac{{V}_{read\_nom}}{{V}_{read\_act}}}}{{B}_{written * \frac{{V}_{read\_nom}}{{V}_{read\_act}}}} = \frac{{A}_{written}}{{B}_{written}} = \frac{- {f}_{1} ( PES ) + {f}_{2} ( PES )}{- {f}_{1} ( PES ) + {f}_{3} ( PES )} & Equation 8\end{matrix}$$

As shown by Equation 8, a ratio of the measured time intervals A and B of a head detecting servo pattern 200 can be used to eliminate an average read velocity error over the period in which servo pattern 200 is detected by the head for any PES. However, Equation 8 may be a complicated formula depending on f₁, f₂ and f₃. For this reason, in some instances it may be useful to use a look-up table instead of a formula to relate time measurements between the detection of marks 201, 202 and 203 to a position error.

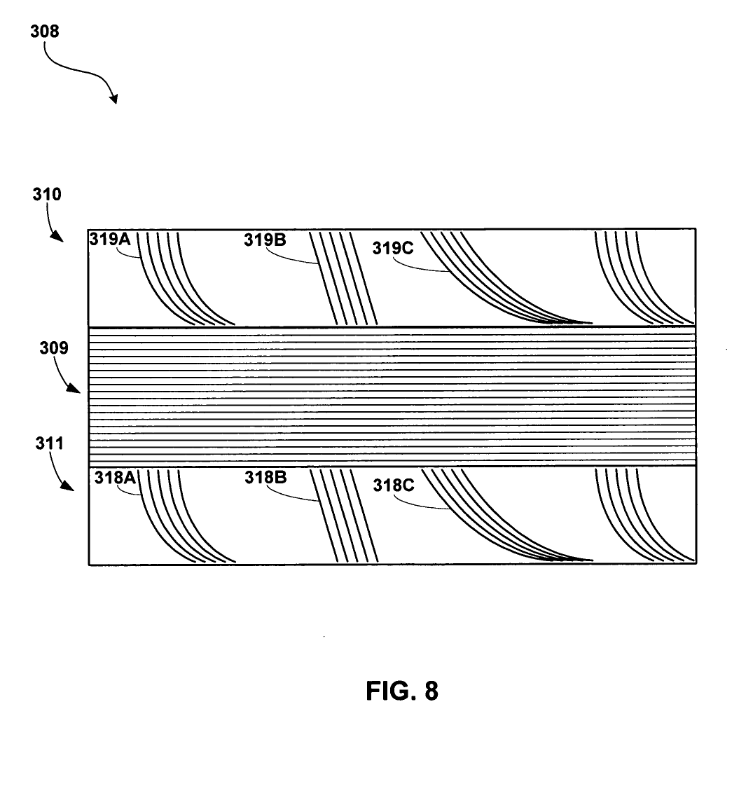

However, in order to simplify the calculation of a position error, servo marks 201, 202, and 203 may be configured such that the ratio of A/B has a linear relationship with the position error of a head detecting servo mark 200. One example of such geometry is shown in FIG. 7.

FIG. 5 is a conceptual view of servo pattern 218, which includes three linear servo marks 231, 232 and 233. Each of servo marks 231, 232 and 233 has a predetermined non-identical geometry. Servo pattern 218 is configured to allow for calculation of a PES relative to pattern centerline 220 for a head detecting servo pattern 218. Servo pattern 218 is also configured such that the PES calculation substantially mitigates error resulting from a variation in velocity of the data storage tape, e.g., using Equation 8.

Because each of servo marks 231, 232 and 233 are linear, the function defining each of servo marks can be represented as a simple linear equation:

fᵢ=mᵢX+bᵢ Equation 9

In Equation 9, m is the slope of the servo mark and b is the intercept. Substituting Equation 9 into Equation 8 produces:

$$PES = \frac{{b}_{1} - {b}_{2} + \frac{A}{B} ( - {b}_{1} + {b}_{3} )}{{m}_{2} - {m}_{1} + \frac{A}{B} ( {m}_{1} - {m}_{3} )} \qquad Equation 10$$

As demonstrated by Equation 10, if m₁ is the same as either m₂ or m₃, PES is a linear function of A/B. However, even if m₁ is not the same as either m₂ or m₃, Equation 10 can still be used to determine PES using a measured ratio of A/B. Equation 10 relates to Θ₁, Θ₂ A_{NOM}, and B_{NOM} according to the following equations:

m₁=tan (Θ₁) Equation 11

m₂=−tan (Θ₁) Equation 12

m₃=tan (Θ₂) Equation 13

b₁=0 Equation 14

b₂=A_{NOM} Equation 15

b₃=B_{NOM} Equation 16

For example, with respect to servo pattern 218, if Θ₁ is 6 degrees and Θ₂ is 7 degrees, A_{NOM} is 50 micrometers and B_{NOM} is 100 micrometers, Equation 10 can be solved to produce:

$$PES = 36.827 {( \frac{A}{B} )}^{2} - 493.44 ( \frac{A}{B} ) + 237.51 \qquad Equation 17$$

For servo pattern 218, the actual tape speed velocity can be calculated using the PES and from either one of A or B using the known geometry of marks at the calculated PES. A more accurate actual tape speed velocity may be determined using only B rather than only A, as servo marks 231 and 233 are spaced the furthest apart.

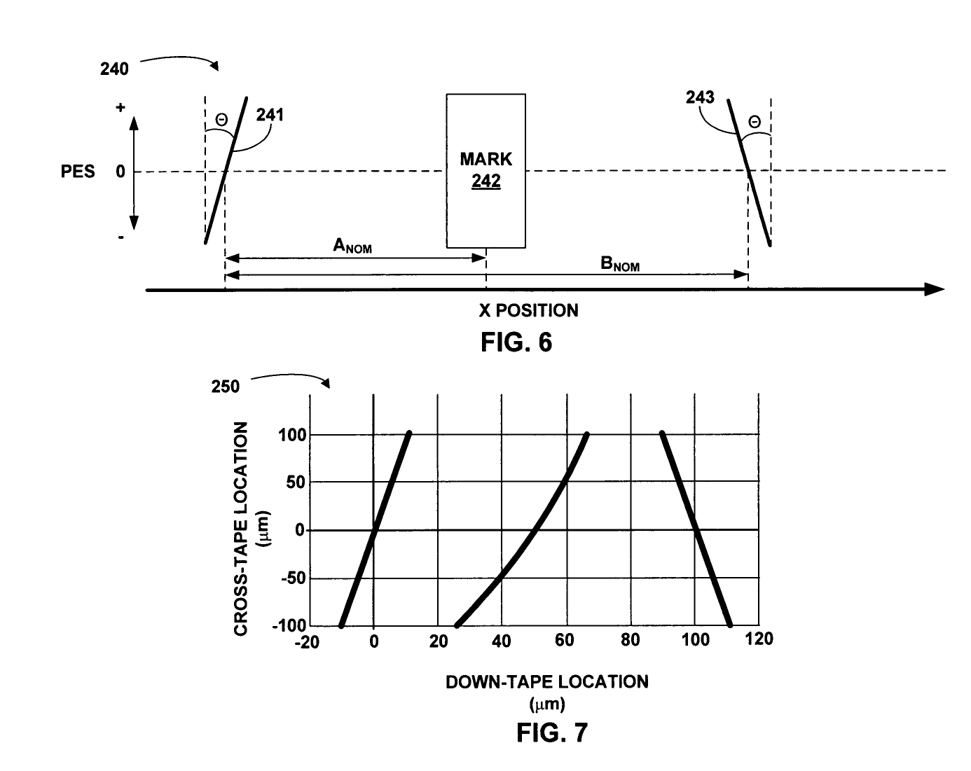

Equation 17 is non-linear and therefore relatively complex. As described with respect to FIG. 6, it is possible to configure a servo pattern including three non-identical marks such that A/B is linearly related to a cross-tape position, i.e., linearly related to a PES.

In FIG. 6, servo pattern 240 includes three servo marks: 241, 242 and 243. Servo marks 241 and 243 are linear servo marks. Servo mark 242 is a non-linear servo mark that may be configured such that the ratio of A/B has a linear relationship with the position error of a head detecting servo mark 200. Servo mark 242 may be defined as a second order formula as shown in Equation 18. Equation 18 is input into Equation 8 as shown below in Equations 19 and 20 to relate PES with A/B.

$$\begin{matrix}{f}_{2} = {a}_{2} * {PES}^{2} + {b}_{2} * PES + {c}_{2} & Equation 18 \\ ratio = \frac{{A}_{read}}{{B}_{read}} = \frac{- {m}_{1} PES - {b}_{1} + {a}_{2} {PES}^{2} + {b}_{2} PES + {c}_{2}}{- {m}_{1} PES - {b}_{1} + {m}_{3} PES + {b}_{3}} & Equation 19 \\ PES * ( {m}_{1} ratio - {m}_{3} ratio - {m}_{1} + {a}_{2} PES + {b}_{2} ) = ratio * ( {b}_{3} - {b}_{1} ) + {b}_{1} - {c}_{2} & Equation 20\end{matrix}$$

In order to define a₂, b₂ and c₂ a range of A/B for a given range of PES needs to be defined. For example, the range of A/B can be set to be 0.3 to 0.7 for a range of PES of minus 100 micrometers to 100 micrometers. Given a linear relationship between A/B and PES, A/B is equal to 0.5 at a PES of 0. Using these values allows calculation of a₂, b₂ and c₂ according to the following equations:

$$\begin{matrix}0 = ratio * ( {b}_{3} - {b}_{1} ) + {b}_{1} - {c}_{2} & Equation 21 \\ {c}_{2} = 0.5 * ( {b}_{3} - {b}_{1} ) + {b}_{1} & Equation 22 \\ PES * ( {m}_{1} ratio - {m}_{3} ratio - {m}_{1} + {a}_{2} PES + {b}_{2} ) = ratio * ( {b}_{3} - {b}_{1} ) + {b}_{1} - {c}_{2} & Equation 23 \\ {m}_{1} ratio - {m}_{3} ratio - {m}_{1} + {a}_{2} PES = 0 then & Equation 24 \\ PES = \frac{ratio * ( {b}_{3} - {b}_{1} ) + {b}_{1} - {c}_{2}}{{b}_{2}} & Equation 25 \\ {b}_{2} = \frac{ratio * ( {b}_{3} - {b}_{1} ) + {b}_{1} - 0.5 * ( {b}_{3} - {b}_{1} ) - {b}_{1}}{PES} & Equation 26 \\ {b}_{2} = \frac{0.7 * ( {b}_{3} - {b}_{1} ) + {b}_{1} - 0.5 * ( {b}_{3} - {b}_{1} ) - {b}_{1}}{100} = \frac{0.2 * ( {b}_{3} - {b}_{1} )}{100} = 0.002 * ( {b}_{3} - {b}_{1} ) & Equation 27 \\ 100 * ( 0.7 {m}_{1} - 0.7 {m}_{3} - {m}_{1} + 100 {a}_{2} + 0.002 * ( {b}_{3} - {b}_{1} ) ) = 0.7 * ( {b}_{3} - {b}_{1} ) + {b}_{1} - 0.5 * ( {b}_{3} - {b}_{1} ) - {b}_{1} - 30 {m}_{1} - 70 {m}_{3} + 10000 {a}_{2} + 0.2 * ( {b}_{3} - {b}_{1} ) 0.2 * ( {b}_{3} - {b}_{1} ) & Equation 28 \\ {a}_{2} = 0.003 {m}_{1} + 0.007 {m}_{3} & Equation 29\end{matrix}$$

Equations 22, 27 and 29 define a₂, b₂ and c₂ to configure servo mark 242 according to Equation 18 such that servo pattern 240 provides a linear relationship between PES and A/B. For clarity in the derivation of claim 27, Equation 20 is reproduced as Equation 23. With respect to FIG. 6, the elements m₁, m₃, b₁, b₃ and c₂ relate to Θ, A_{NOM} and B_{NOM} according to the following equations:

m₁=tan (Θ) Equation 30

m₃=−tan (Θ) Equation 31

b₁=0 Equation 32

c₂=A_{NOM} Equation 33

b₃=B_{NOM} Equation 34

For example, with respect to servo pattern 240, if Θ is 6 degrees and B_{NOM} is 100 micrometers, then servo mark 242 is defined according to Equation 18 such that:

a₂=−0.004*tan (6°) Equation 35

b₂=0.2 Equation 36

c₂=50 Equation 37

Inputting those values into Equation 25 produces the linear equation that relates A/B to the PES, i.e., to the cross-tape position of a head measuring time intervals that correspond to A and B:

PES=250*(ratio*2−1) Equation 38

FIG. 7 is a scaled illustration of servo pattern 250, which is the derivation of servo pattern 240 as calculated above with respect to Equations 18-38. Servo pattern 250 provides a linear cross-tape position error to A/B ratio and substantially mitigates an error in the calculated cross-tape position resulting from a variation in velocity of the data storage tape during detection of servo pattern 240.

Using exactly two linear servo marks in a servo pattern is the simplest manner to configure a servo pattern including three servo marks with non-identical geometries to provide a linear cross-tape position error to A/B ratio. Because the servo pattern includes at least three servo marks, it can also be used to substantially mitigate an error in the calculated cross-tape position resulting from a variation in velocity of the data storage tape during detection of servo pattern. However, two or three non-linear servo marks may also be used in a servo pattern having three marks configured to provide a linear cross-tape position error to A/B ratio. One example of such a pattern is shown on data storage tape 308 in FIG. 8.

In FIG. 8, data storage tape 308 includes servo bands 310 and 311 and data tracks 309. Servo bands 310 and 311 each include a series of identical servo patterns. Each servo pattern in the series includes three servo marks, of which two are non-linear servo marks and one is a linear servo mark. For example, the first servo pattern in servo band 310 includes servo marks 319A, 319B and 319C. Similarly, the first servo pattern in servo band 311 includes servo marks 318A, 318B and 318C.

Each of the servo patterns on data storage tape 308 is configured to allow a PES calculation for the head that substantially mitigates error resulting from a variation in velocity of data storage tape 308. Additionally, the geometry of the servo marks is configured to provide a linear PES calculation. A similar methodology to that used to determine the geometry of servo pattern 250 (FIG. 7) may be used to determine the geometry of the servo patterns on data storage tape 308. For example, the geometry of two of the servo marks in a servo pattern, e.g., servo marks 319A and 319B, may be pre-selected. The geometry of the third servo mark in the servo pattern, e.g., servo mark 319C, may then be calculated using Equation 8 and at least two points to define a linear PES versus A/B ratio. For example, to define servo mark 242 to produce servo pattern 250, the selected points were: (0.3, −100 micrometers) and (0.7, 100 micrometers).

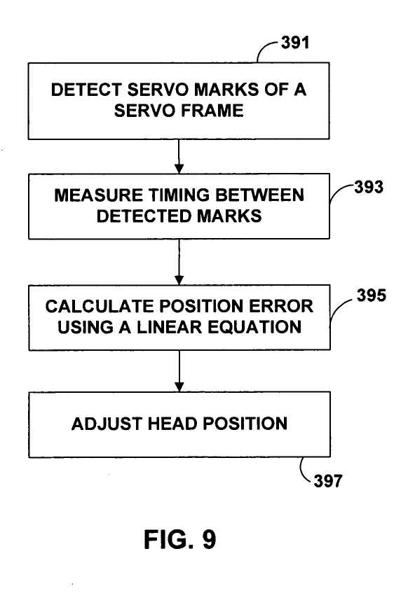

FIG. 9 is a flow diagram illustrating techniques for adjusting the position of a read head within a servo band by measuring the time between detection of servo marks on a data storage tape. For illustration purposes, the techniques shown in FIG. 8 are described with reference to data storage tape 8 of FIG. 3.

Data storage tape 8 passes the read head (not shown in FIG. 3) located along head path 16A relative to data storage tape 8. As data storage tape 8 passes the head, the read head first detects the servo marks in burst 19A, followed by the servo marks in bursts 19B and 19C (391). As the section of data storage tape 8 including servo frame 19C passes the head, a controller (not shown in FIG. 3) measures the timing between detected marks (393). There are a total of fifteen marks in servo frame 12A, and the controller stores the timing of each of these servo marks. Because each servo mark causes the same signal response in the head, the controller counts each mark to determine its significance. For example, the controller knows that the first mark in servo frame 12A combines with the sixth mark and the eleventh mark (servo mark 17A) to form the first servo pattern. Using the timing of marks from each servo pattern, the controller calculates a PES for the head according to a cross-tape position of the head relative to the data storage tape according to time intervals between the detection of the first servo mark, the second servo mark and the third servo mark (395). For example, the controlled may use a linear equation to relate TIME A/TIME B to the PES. As previously described, the calculation may substantially mitigate an error in the calculated PES resulting from a variation in velocity of the data storage tape. The controller may average position errors calculated from the timing of the marks from each of the servo patterns in servo frame 12A. The controller then uses the calculated position error of the head to adjust the lateral position of the head relative to data storage tape 8 (397).

Various embodiments of the invention have been described. Nevertheless, various modifications may be made without departing from the scope of the invention. For example, in some embodiments, servo patterns may be located within data tracks rather than only in servo bands adjacent to data tracks. Additionally, while techniques for providing a linear PES calculation were described for servo patterns having exactly three servo marks, servo patterns having more than three servo marks may also be used. These and other embodiments are within the scope of the following claims.

1. A data storage tape comprising:
one or more data tracks; and
a series of servo patterns to facilitate head positioning relative to the data tracks,
wherein each of the servo patterns includes a first servo mark, a second servo mark and a third servo mark,
wherein at least one of the first servo mark, the second servo mark and the third servo mark is a non-linear servo mark,
wherein a distance “A” is defined as a first distance in a down-tape direction between the first servo mark and the second servo mark,
wherein a distance “B” is defined as a second distance in a down-tape direction between the first servo mark and the third servo mark,
wherein A/B is linearly related to a cross-tape position at which A and B are defined.

2. The data storage tape of claim 1, further comprising a servo band that includes the series of servo patterns.

3. The data storage tape of claim 2, wherein the series of servo patterns are grouped into distinct servo frames within the servo band.

4. The data storage tape of claim 1, wherein the servo patterns in the series are configured to allow calculation of a position error signal for a head detecting at least one of the servo patterns in the series at the cross-tape position, wherein the calculation of the position error signal substantially mitigates error resulting from a variation in velocity of the data storage tape during detection of the at least one of the servo patterns in the series.

5. The data storage tape of claim 1, wherein the second servo mark is the non-linear servo mark.

6. The data storage tape of claim 1, wherein each of the servo patterns in the series have a substantially identical shape.

7. The data storage tape of claim 1, wherein the data storage tape is a magnetic data storage tape.

8. A method comprising:
detecting a first servo mark, a second servo mark and a third servo mark of a servo pattern on a data storage tape with a head,
wherein the first servo mark, the second servo mark and the third servo mark have non-identical geometries; and
calculating a position error signal according to a cross-tape position of the head relative to the data storage tape according to time intervals between the detection of the first servo mark, the second servo mark and the third servo mark,
wherein calculating the position error signal substantially mitigates an error in the calculated position error signal resulting from a variation in velocity of the data storage tape during detection of the first servo mark, the second servo mark and the third servo mark.

9. The method of claim 8,
wherein a distance “A” is defined as a distance in a down-tape direction between the first servo mark and the second servo mark at the cross-tape position,
wherein a distance “B” is defined as a distance in a down-tape direction between the first servo mark and the third servo mark at the cross-tape position,
wherein a ratio of the cross-tape position to A/B is linear.

10. The method of claim 8, wherein each of the first servo mark, the second servo mark and the third servo mark are linear servo marks.

11. The method of claim 8, wherein at least one of the first servo mark, the second servo mark and the third servo mark is a non-linear servo mark.

12. The method of claim 8, further comprising adjusting the cross-tape position of the head according to the position error signal.

13. The method of claim 8, wherein the data storage tape is a magnetic data storage tape.

14. A data storage tape comprising:
one or more data tracks; and
a series of servo patterns to facilitate head positioning relative to the data tracks,
wherein each of the servo patterns include a first non-linear servo mark and a second non-linear servo mark.

15. The data storage tape of claim 14, wherein the servo patterns in the series are configured to allow calculation of a position error signal for a head detecting at least one of the servo patterns in the series, wherein the position error signal calculation substantially mitigates error resulting from a variation in velocity of the data storage tape during detection of the at least one of the servo patterns in the series.

16. The data storage tape of claim 14,
wherein each servo pattern in the series includes a first servo mark, a second servo mark and a third servo mark,
wherein a distance “A” is defined as a first distance in a down-tape direction between the first servo mark and the second servo mark,
wherein a distance “B” is defined as a second distance in a down-tape direction between the first servo mark and the third servo mark,
wherein A/B is linearly related to a cross-tape position at which A and B are defined.

17. The data storage tape of claim 16, wherein the servo patterns in the series are configured to allow calculation of a position error signal for a head detecting at least one of the servo patterns in the series, wherein the position error signal calculation substantially mitigates error resulting from a variation in velocity of the data storage tape during detection of the at least one of the servo patterns in the series.

18. The data storage tape of claim 14, wherein each of the servo patterns in the series written to the data storage tape by the same servo head.

19. The data storage tape of claim 14, further comprising a servo band that includes the series of servo patterns.

20. The data storage tape of claim 15, wherein the data storage tape is a magnetic data storage tape.
